(19) United States
(12) Patent Application Publication
(10) Pub. No.: US 2017/0356552 A1
(43) Pub. Date: Dec. 14, 2017

(54) MULTI-ORIFICE PLATE FLOW VALVE

(71) Applicant: EcoTec Solutions, Inc., Colton, CA (US)

(72) Inventor: Mitchal Cassel, Redlands, CA (US)

(21) Appl. No.: 15/618,779

(22) Filed: Jun. 9, 2017

Related U.S. Application Data
(60) Provisional application No. 62/348,454, filed on Jun. 10, 2016.

(51) Int. Cl. F16K 3/02; F16K 31/53; F16K 31/04; F16K 37/00; F16K 31/60

(52) U.S. Cl. CPC F16K 3/0209; F16K 37/0041; F16K 31/60; F16K 31/041; F16K 31/535; F16K 37/005; F16K 37/0058

(57) ABSTRACT

A multi-orifice plate flow valve system is disclosed which comprises a flow control valve including a multi-orifice plate and a plurality of gear wheels. The flow rate through the valve system can be adjusted through a gear train manually via a handle and/or automatically via a motor. Orifices having different size apertures can be rotated into the transport path within the same flow control valve. The multi-orifice plate can include setting indicators, which visually communicates to a user the size of orifice aperture in the transport path. In some embodiments, a pressure transducer and/or gear position sensor can provide determination of flow rate through the valve system.

### INCORPORATION BY REFERENCE TO ANY PRIORITY APPLICATIONS

This application claims the benefit of U.S. Provisional Application Ser. No. 62/348,454, filed Jun. 10, 2016, entitled “MULTI-ORIFICE PLATE FLOW VALVE,” which is hereby incorporated by reference in its entirety and for all purposes.

### BACKGROUND

Various entities utilize fluid transport systems to transport fluids such as liquids or gases (e.g., natural gas, biogas, etc.). For example, energy developers, petroleum companies, coal mines, landfills, and various other entities may utilize fluid transport systems. It may be desirable to control the flow rate of a fluid through a fluid flow pipe or other component of a fluid transport system.

### SUMMARY

The present disclosure relates to multi-orifice plate flow valve systems and, in particular, multi-orifice plate flow valve systems configured to easily adjust and/or determine the flow rate of fluid to one of a plurality of settings.

The systems, methods and devices described herein have innovative aspects, no single one of which is indispensable or solely responsible for their desirable attributes. Without limiting the scope of the claims, some of the advantageous features will now be summarized.

In a first embodiment, a flow control valve is described. The flow control valve includes an intake socket, an outlet socket spaced from the intake socket along a flow axis of the flow control valve, a generally circular multi-orifice plate, and a gear wheel mechanism. The multi-orifice plate has a center and a plurality of orifices spaced circumferentially about the center and extending through the multi-orifice plate, wherein each of the plurality of orifices is located at a radial distance from the center of the multi-orifice plate such that each orifice can be positioned along the flow axis between the intake socket and the outlet socket by rotating the multi-orifice plate about the center. The gear wheel mechanism is configured to rotate the multi-orifice plate about the center within a plane generally defined by the multi-orifice plate.

A first orifice of the multi-orifice plate can have a first cross sectional area and a second orifice of the multi-orifice plate can have a second cross sectional area greater than the first cross sectional area. Each of the plurality of orifices can have a cross sectional area different from the cross sectional areas of the other orifices. At least two of the plurality of orifices can have cross sectional areas between 25% and 75% of the cross sectional area of the intake socket. At least one orifice of the multi-orifice plate can have a circular shape. At least one orifice of the multi-orifice plate can have a non-circular shape.

The flow control valve can further include a valve housing at least partially enclosing the multi-orifice plate. The flow control valve can further include a plurality of o-rings sealing disposed about the flow axis between the multi-orifice plate and the valve housing. The multi-orifice plate can further include a plurality of alphanumeric indicators each corresponding to a size of one of the plurality of orifices, the alphanumeric indicators being positioned on the multi-orifice plate such that, when a particular orifice of the plurality of orifices is positioned along the flow axis, the corresponding alphanumeric indicator is visible to an observer through an aperture of the valve housing.

The flow control valve can further include a pressure sensor configured to produce an output indicative of a fluid pressure within an interior space of the flow control valve. The flow control valve can further include processing circuitry configured to calculate a rate of fluid flow through the flow control valve based at least in part on the output of the pressure sensor. The processing circuitry can be configured to calculate the rate of fluid flow based on the output of the pressure sensor and a cross sectional area of an aperture disposed along the flow axis of the flow control valve. The flow control valve can further include a valve position sensor configured to produce an output indicative of a size of an aperture disposed along the flow axis based at least in part on an initial position of the multi-aperture plate and a number of rotations of a portion of the gear wheel mechanism.

The flow control valve can further include a motor coupled to the gear wheel mechanism, wherein the motor is configured to actuate the gear wheel mechanism. A circumferential edge of the multi-orifice plate can include a plurality of cogs configured to engage with a gear of the gear wheel mechanism such that actuation of the gear wheel mechanism results in rotation of the multi-orifice plate.

### BRIEF DESCRIPTION OF THE DRAWINGS

The above-mentioned aspects, as well as other features, aspects, and advantages of the present technology will now be described in connection with various embodiments, with reference to the accompanying drawings. The illustrated embodiments, however, are merely examples and are not intended to be limiting. Like reference numbers and designations in the various drawings indicate like elements.

FIG. 1 is a perspective view of an exemplary embodiment of a multi-orifice plate flow valve system.

FIG. 2 is a top perspective view of the exemplary multi-orifice plate flow valve system of FIG. 1.

FIG. 3 is an exploded view of the exemplary multi-orifice plate flow valve system of FIGS. 1 and 2.

FIG. 4 is a cutaway view illustrating internal components of the exemplary multi-orifice plate flow valve system of FIGS. 1-3.

FIG. 5 is a cross sectional view taken about the flow axis of the exemplary multi-orifice plate flow valve system of FIGS. 1-4.

FIG. 6 is a close perspective view of various internal components of the exemplary multi-orifice plate flow valve system of FIGS. 1-5.

### DETAILED DESCRIPTION

In the following detailed description, reference is made to the accompanying drawings, which form a part of the present disclosure. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, illustrated in the figures, can be arranged, substituted, combined, and designed in a wide variety of different configurations, all of which are explicitly contemplated and form part of this disclosure. For example, a system or device may be implemented or a method may be practiced using any number of the aspects set forth herein. In addition, such a system or device may be implemented or such a method may be practiced using other structure, functionality, or structure and functionality in addition to or other than one or more of the aspects set forth herein. Alterations in further modifications of the inventive features illustrated herein, and additional applications of the principles of the inventions as illustrated herein, which would occur to one skilled in the relevant art and having possession of this disclosure, are to be considered within the scope of the invention.

Descriptions of the necessary parts or elements may be omitted for clarity and conciseness, and like reference numerals refer to like elements throughout. In the drawings, the size and thickness of layers and regions may be exaggerated for clarity and convenience.

### An Exemplary Multi-Orifice System

Generally described, aspects of the present disclosure relate to flow valve systems configured to easily adjust and/or determine the flow rate of fluid to one of a plurality of settings. In some aspects, a multi-orifice plate is provided within a flow valve system and configured generally perpendicular to a fluid flow axis. The orifices extending through the plate can be arranged circumferentially around the plate such that an orifice of a desired size can be positioned along the fluid flow axis by rotating the multi-orifice plate so as to control a fluid flow rate through the flow valve system.

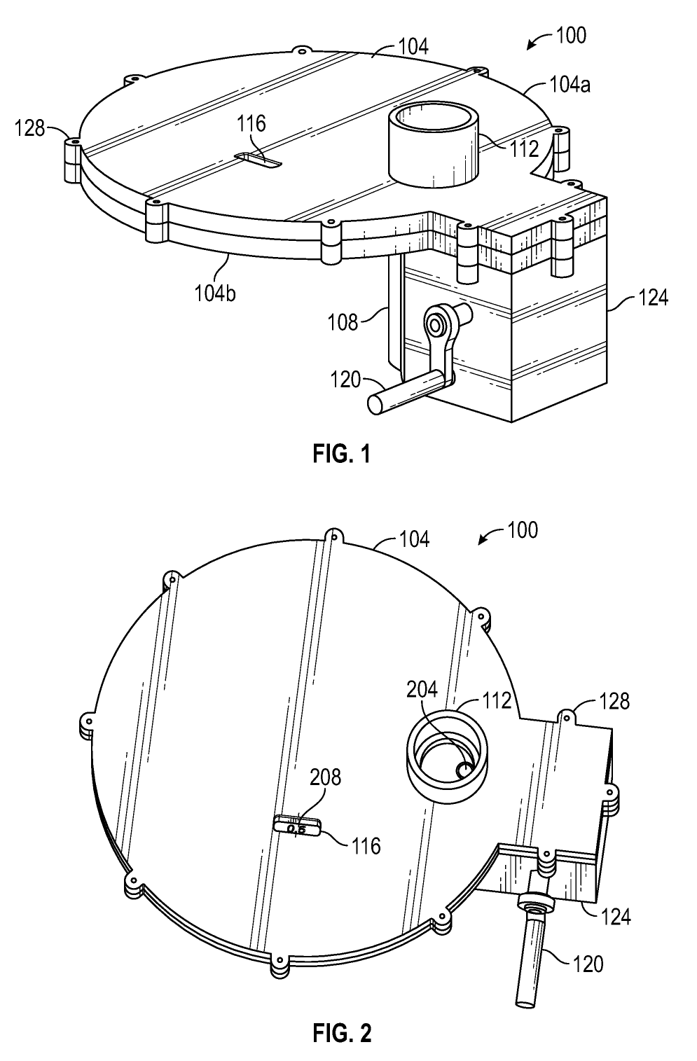

FIG. 1 illustrates a perspective view of one embodiment of a multi-orifice plate flow valve system 100. The exemplary system comprises an intake socket 108 and an outlet socket 112 sized for coupling with external fluid flow pipes. The inner circumferences of the intake and outlet sockets can be, but need not be, of the same size. For example, the socket connected to the source of fluid (e.g., the intake socket 108) can have a larger inner circumference than the socket connected to the destination of the fluid (e.g., the outlet socket 112). The intake and outlet sockets can mate with pipes (e.g., with or without connectors/adapters, couplers, adhesives, or the like) to incorporate the valve system 100 to provide flow control within any fluid flow system. Such pipes can be substantially cylindrical in shape. The valve system can support pipes of different sizes, for example, pipes with a diameter within the range of between 0.5 inches and 6 inches, 1 inch to 3 inches, or other suitable range.

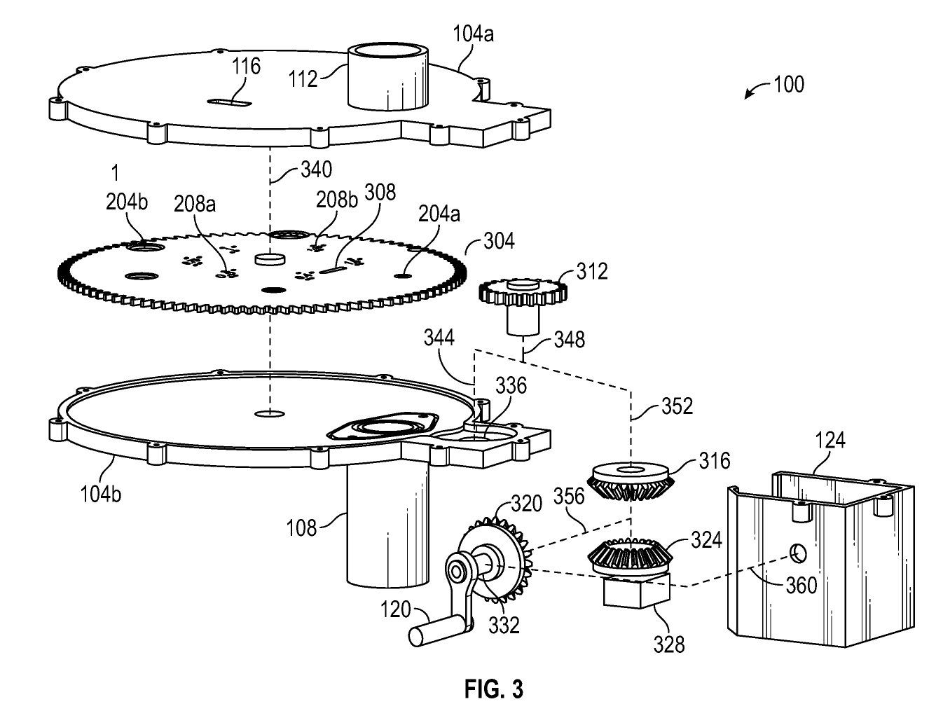

The multi-orifice plate flow valve system 100 can be used to control the rate of fluid flow through the flow valve system 100 to one of a plurality of flow rates. In this embodiment, the flow rate is controlled through use of orifices of varying sizes that may be alternatively positioned in-line with the flow axis of the system 100, the flow axis (also referred to herein as a fluid transport path) extending through a central axis of the intake socket 108 and through a central axis of the outlet socket 112. As described below with reference to FIG. 3, a multi-orifice plate within the system 100 can include multiple orifices of varying sizes. For example, a series of orifices that allow from 25% (for a smallest orifice size) to 75% (for the largest orifice size) flow through the valve may be used. Depending on the embodiment, the number, size, and position of the orifices on the orifice plate may be adjusted. In another example embodiment, the orifices may provide a narrower range of flow (with reference to the maximum flow through the valve if no orifice is used), such as 25-45% of maximum flow.

A user of the system can adjust a position of the multi-orifice plate 304 to select a desired orifice (and corresponding flow rate) for a flow system in which the valve 100 is implemented. For example, position of the orifices on the multi-orifice plate can be adjusted through rotation of a multi-orifice plate contained within a flange 104. In the embodiment of FIG. 1, the flange 104 comprises an upper piece 104a and a lower piece 104b. The multi-orifice plate 304 can have a substantially planar shape and be placed between the upper and lower pieces of the flange. One or more protrusions 128 with openings may be placed around the perimeters of the flange to more securely seal the upper and lower pieces of the flange together through placing fasteners (e.g., screws, bolts, rivets, etc.) in the openings. In some embodiments, the flange may be further, or alternatively, sealed by one or more o-ring seals or gaskets. FIG. 1 shows an embodiment with nine protrusions at the perimeters of the flange. An embodiment may have more or fewer protrusions. An embodiment may locate openings for fasteners at different positions, e.g., within the perimeters of the flange without protrusions.

As shown in FIG. 2, the size of a particular orifice of the orifice plate that is currently in line with the flow axis of the system 100 can be indicated in an opening 116 in the flange. The handle 120 can be used to rotate the multi-orifice plate, thus changing the flow rate. A gear/motor protective cover 124 houses mechanisms such as gears and motors. In the embodiment illustrated in FIGS. 1 and 2, the gear/motor box (with perimeters defined by the protective cover 124) is positioned relatively close to the sockets. Other embodiments may locate the gear/motor box in a different position relative to the sockets. In some embodiments, the position of the multi-orifice plate can be adjusted manually, such as using a crank handle 120 illustrated in FIG. 1, and/or may be adjusted using a motorized apparatus, such as an electrical motor that rotates the multi-orifice plate.

As shown in FIG. 2, an eccentric orifice 204 is located in the fluid transport path through the intake and outlet sockets 108, 112. The eccentric orifices of this example multi-orifice plate are positioned so that their outer circumferences are substantially aligned with the inner circumference of outlet socket 112 and/or the inner circumference of intake socket 108 (not shown), rather than being centered within the area of the sockets 112, 108. In some embodiments, for example, where the system 100 is controlling a flow rate of a liquid and the flow axis is generally horizontal, the eccentric orifice 204 can be positioned such that its aperture is in a low portion of the substantially horizontal transport path. This positioning facilitates the flow of fluid at different volumes of flow. For example, when fluid from a source fills up only a portion of the sockets (e.g., a lower portion due to gravity keeping the fluid on a lower portion of the fluid transport path), an increased amount of the fluid can still flow through the orifice given its eccentric positioning at the lower side of the sockets. Some embodiments can position the lowest point on the outer circumference of the eccentric orifice 204 at the points on the inner circumferences of the sockets closest to the ground. The eccentric orifice 204 is illustrated as substantially circular in the embodiment of FIG. 2. In other embodiments the eccentric orifice 204 may be shaped differently. For example, a rectangular, or square orifice may be used.

Although sockets 108 and 112 are referred to as the intake and outlet socket, respectively, the system 100 is operable if the direction of fluid flow is the opposite, e.g., 108 functions as an outlet socket and 112 functions as an intake socket.

### Multi-Orifice Plate & Indicator

With continue reference to FIG. 2, a setting indicator 208 can show the setting of the multi-orifice plate flow valve system through the opening 116 in the flange 104. For example, the display can show the diameter of the orifice 204 (e.g., 0.5″ as shown in FIG. 2). In various embodiments, the display can show the setting through other quantities or quantitative measures, e.g., flow rate in gallons per minute at a certain fluid pressure level. The outlet socket 112 (and intake socket 108), the opening 116, the setting indicator 208, and the orifice 204 are positioned such that the setting indicator 208 shows a setting through the opening 116 corresponding to the orifice 204 in the transport path through outlet socket 112. This is further described in connection with FIG. 3 below.

FIG. 3 illustrates an exploded view of the flow valve system 100 according to one embodiment. In this example, the upper flange 104a and the outlet socket 112 are formed as a single piece, such as by plastic molding. The flange 104a also includes the opening 116 for viewing information regarding the currently selected orifice. In this example, the lower flange 104b and the intake socket 108 are also formed as a single piece, such as by plastic molding. The planar portions of the upper flange 104a and of the lower flange 104b have substantially the same shape, allowing them to mate together to form an enclosure. A multiple orifice plate/internal gear wheel 304 (or simply “multi-orifice plate 304”) can reside within the enclosure. In this example, the multi-orifice plate 304 is substantially circular in shape, with cogs on its outer circumference for interfacing with other adjustment gears, as discussed below.

As illustrated in FIG. 3, the multi-orifice plate 304 of the exemplary flow valve system 100 includes six orifices, including orifices 204a and 204b. The six orifices can be spaced approximately equally on the circular plane of the multi-orifice plate 304, e.g. lines from a central axis 340 of the plate 304 to the center of two adjacent orifices form roughly 60° angles (for a six-orifice plate). In other embodiments, unequal spacing of the orifices on an orifice plate 304 may be used. In various embodiments, more or fewer than six orifices may be present. As few as two orifices can support a multi-orifice plate flow valve system. A multi-orifice plate can include as many orifices as desired. In certain embodiments, it may be desirable to limit the number of orifices such that no two adjacent orifices or portions thereof are in the transport path when the multi-orifice plate is positioned in an operational rotation (a position intended to facilitate fluid flow through the system, e.g., with one orifice within transport path) to control fluid flow. An implementation of multi-orifice plate can leave sufficient space between adjacent orifices such that no two adjacent orifices or portions thereof are in the transport path at the same time even when the multi-orifice plate is being adjusted from one orifice to another.

The sizes of the orifices can vary depending on the application. For example, a valve system may have orifices with sizes ranging from 25% to 75% of the pipe opening. As another example, in a fluid delivery system with oversized pipes, a valve system may have orifices with sizes ranging from 25% to 45% of the pipe opening.

Also as illustrated in FIG. 3, the multi-orifice plate 304 includes six setting indicators, including 208a and 208b (but excluding carving 308), one for each orifice. Each of the setting displays corresponds to one of the orifices. For example, setting indicator 208a corresponds to orifice 204a. Setting indicator 208a shows through the opening 116 when the corresponding orifice 204a is in the fluid transport path formed by the sockets 108 and 112. Setting indicator 208b corresponds to orifice 204b. Accordingly, when the multi-orifice plate 304 is rotated such that the orifice 204b is in the transport path, setting indicator 208b shows through the opening. This provides the advantage that a user can easily determine the size of the active orifice (the orifice in the transport path) or the corresponding flow rate by examining the visible setting display.

### Gear Wheel System

In the exemplary implementation, the crank cylinder 332 of the handle 120 is connected to a first external gear wheel 320 through an opening in the gear/motor protective cover 124 along a crank cylinder axis 360. The crank cylinder 332 is substantially cylindrical in shape. The longitudinal axis 356 of the crank cylinder 332 is aligned with the center of the substantially circular external gear wheel 320. Rotating the handle 120 in a circular motion causes the crank cylinder 332 and the external gear wheel 320 to spin around the central longitudinal axis 356 of the crank cylinder 332.

The first external gear wheel 320 has cogs around its outer circumference. A second external gear wheel 316 is substantially circular in shape and has matching cogs around its outer circumference. When assembled in an operational configuration (e.g., a portion of the gears of each of the wheels 320 and 316 are engaged), the first and the second external gear wheels 320, 316 interface such that the rotational motion of the first external gear wheel 320 causes the second external gear wheel 316 to spin around its central axis, thus translating motion about the central longitudinal axis of the crank cylinder 332 to motion about a substantially orthogonal axis 352.

The second external gear wheel 316 has a female configuration with an aperture around a central axis 352. An internal gear wheel 312 has a male configuration with a cylindrical protrusion around a central axis 348. When assembled in an operational configuration, the cylindrical protrusion of the internal gear wheel mates with the aperture of the second external gear wheel through an opening 336 in the lower flange 104b (e.g., the axes 348 and 352 are aligned with the central axis 344 through opening 336). This mating can transfer the spinning motion of the second external gear wheel 316 to the internal gear wheel 312 such that the two gear wheels can spin together.

The internal gear wheel 312 has cogs around its outer circumference, matching the cogs of the multi-orifice plate 304. When assembled in an operational configuration (e.g., the internal gear wheel 312 interfaces with the multi-orifice plate 304), spinning motion of the internal gear wheel can cause the multi-orifice plate 304 to rotate about its axis 340.

Thus, through the chain reaction of a series of wheel gears, the circular motion of the handle 120 translates to a rotational motion of the multi-orifice plate 304. This in turn moves an orifice on the multi-orifice plate 304 into or out of the apertures of sockets 108 and 112, e.g., into or out of the transport path.

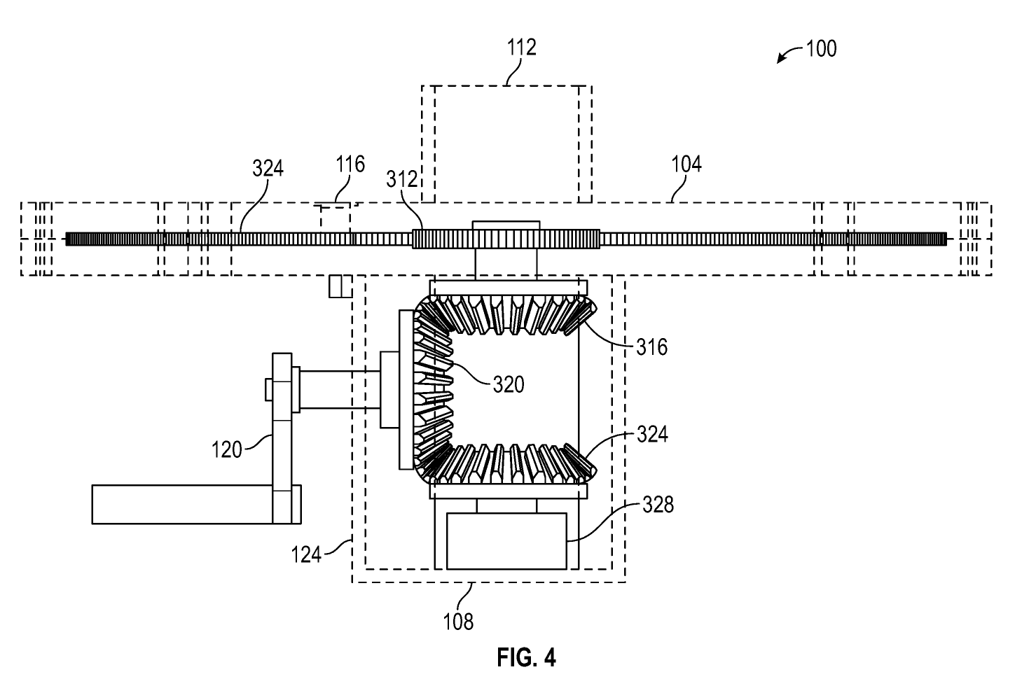

FIG. 4 illustrates a cutaway view of various components of the embodiment of the valve system 100. For example, the first external gear wheel 320 interfaces with the second external gear wheel 316. This interface is located at the end of the first external gear wheel close to the flange. In some embodiments, the first external gear wheel 320 also interfaces with a motor gear wheel 324 coupled to a motor 328. This interface is located at the end of the first external gear wheel 320 close to the motor 328.

Although various figures in the present application illustrate the first external gear wheel 320, the second external gear wheel 316, and the motor gear wheel 324 with bevel gears, other gear types (e.g., spiral bevel, hypoid, etc.) can be used. Similarly, the internal gear wheel 312 and the multi-orifice plate 304 can have one of various types of gears, e.g., spur, helical, double helical, etc.

### Motor and Sensing

The valve system 100 can rotate the multi-orifice plate via manual rotation of the handle 120 and/or via rotation driven by a motor 328, e.g., an electric motor. For example, the motor 328 can be oriented so that its shaft is substantially aligned with the axis 352 and connects with the motor gear wheel 324. When the motor is actuated, its shaft rotates and the motor gear wheel also rotates around the axis 324. When assembled in an operational configuration (e.g., the motor gear wheel 324 interfaces with the first external gear wheel 320), the rotation of the motor gear wheel causes the first external gear wheel to rotate along the axis 356. Through the chain reaction described above, the motor 328 can cause rotation of the multi-orifice plate 304.

A valve system can also provide sensing capability to determine a position of the multi-orifice plate. For example, with information of the initial relative positions of the multi-orifice plate 304 and a gear wheel (e.g., 324, 320, 316, or 312) as well as the relative gear ratios of the various gears in the chain, the position of the multi-orifice plate can be determined from the position and count of the number of rotations of the gear wheel (e.g., 324, 320, 316, or 312). With such sensing capability, the position of the multi-orifice plate 304 and the flow rate can be provided to a remote user through a communication channel; a user does not need to rely on the setting indicator 208 to determine a present flow rate. For example, the flow rate can be provided via a wired or wireless communication channel.

In some embodiments, a pressure transducer can be provided in the outlet socket 112 or elsewhere within an interior portion of the flow valve system 100 to enable calculation of a fluid flow rate through the system based on the size of the orifice and the measured pressure. Thus, the valve system 100 can advantageously support both flow control and flow rate determination. The pressure measurement can be provided to a remote user through the communication channel. An embodiment can have the pressure measurement and/or the sensing capability.

### Seals

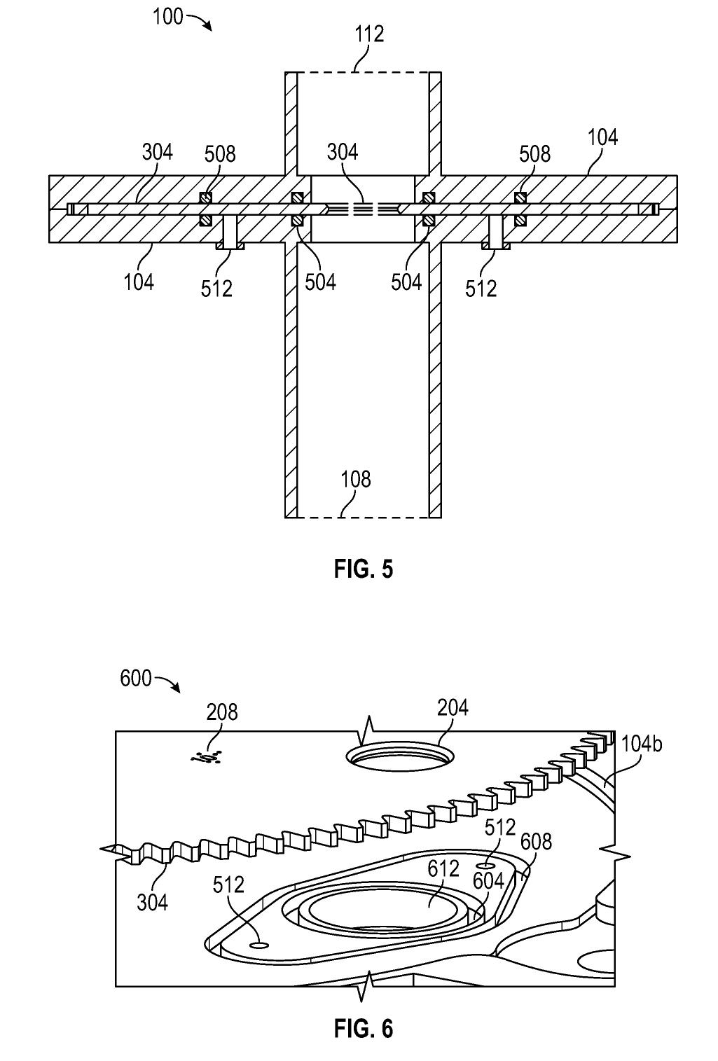

Referring now to FIG. 5, which shows a cross sectional view of the embodiment of the valve system 100, the operation of the multi-orifice plate valve system 100 can be facilitated by the inclusion of one or more seals. Gas flow (or fluid flow) is illustrated as proceeding from intake socket 108 to outlet socket 112 through an orifice in the multi-orifice plate 304. An inner o-ring seal 504 is positioned around the aperture between the intake socket 108 and the outlet socket 112. An outer o-ring seal 508 surrounds an area encompassing two drains with filter (or weep holes) 512. The inner and outer o-rings 508 and 512, such as rubber o-rings that sit in grooves so that only a portion of the o-rings extend from the grooves, create a seal between the multi-orifice plate 304 and the flange 104. The o-rings help prevent fluid from leaking out of their respective enclosures, especially when the multi-orifice plate is rotating. It can be desirable to prevent the fluid from leaking, for example, either out of the valve system 100 or into the gear/motor housing, with or without passing through a filter. The drains with filter 512 provide an escape path for fluid between the inner and outer o-ring seals (such as might occur when the multi-orifice plate 304 is rotated and fluid within the flow channel is pushed outside of the flow path). This can reduce risk of fluid escaping into other portions of the valve system 100, such as the inner portions of the multi-orifice plate 304. These seals may also reduce pressure associated with a leak from the flow path or leak build-up and enhance the capability of the outer o-ring seal in preventing leaks.

FIG. 6 illustrates an enlarged perspective view 600 of the socket aperture 612 and its surrounding. A multi-orifice plate 304 is shown with an orifice 204 and a setting indicator 208. Located on the lower piece of the flange 104b is the socket aperture 612 encircled by a groove 604 for the inner o-ring seal 504. A groove 608 for the outer O-ring seal 508 defines the enclosure area of the outer O-ring seal. The enclosure area encompasses two weep holes 512. An embodiment may have a different number of weep holes, a different number of o-ring seals, different shapes of o-ring enclosures, etc.

The embodiments described above are examples of the system and method. The following claims define the scope of the invention and include the full range of equivalents to which the recited elements of the claims are entitled.

The foregoing description details certain embodiments of the systems, devices, and methods disclosed herein. It will be appreciated, however, that no matter how detailed the foregoing appears in text, the devices and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated. The scope of the disclosure should therefore be construed in accordance with the appended claims and any equivalents thereof.

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

In general, the microprocessors, computing device, and/or processing circuitry discussed herein may each include on or more “components” or “modules,” wherein generally refer to logic embodied in hardware or firmware, or to a collection of software instructions, possibly having entry and exit points, written in a programming language, such as, for example, Java, Lua, C or C++. A software module can be compiled and linked into an executable program, installed in a dynamic link library, or can be written in an interpreted programming language such as, for example, BASIC, Perl, or Python. It will be appreciated that software modules can be callable from other modules or from themselves, and/or can be invoked in response to detected events or interrupts. Software modules configured for execution on computing devices can be provided on a computer readable medium, such as a compact disc, digital video disc, flash drive, magnetic disc, or any other tangible medium, or as a digital download (and can be originally stored in a compressed or installable format that requires installation, decompression or decryption prior to execution). Such software code can be stored, partially or fully, on a memory device of the executing computing device, for execution by the computing device. Software instructions can be embedded in firmware, such as an EPROM. It will be further appreciated that hardware modules can be comprised of connected logic units, such as gates and flip-flops, and/or can be comprised of programmable units, such as programmable gate arrays or processors. The modules or computing device functionality described herein are preferably implemented as software modules, but can be represented in hardware or firmware. Generally, the modules described herein refer to logical modules that can be combined with other modules or divided into sub-modules despite their physical organization or storage.

The term “non-transitory media,” and similar terms, as used herein refers to any media that store data and/or instructions that cause a machine to operate in a specific fashion. Such non-transitory media can comprise non-volatile media and/or volatile media. Non-volatile media includes, for example, optical or magnetic disks, such as storage device. Volatile media includes dynamic memory, such as main memory. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

It is noted that the examples may be described as a process. Although the operations may be described as a sequential process, many of the operations can be performed in parallel, or concurrently, and the process can be repeated. In addition, the order of the operations may be rearranged. A process is terminated when its operations are completed. A process may correspond to a method, a function, a procedure, a subroutine, a subprogram, etc.

The previous description of the disclosed implementations is provided to enable any person skilled in the art to make or use the present disclosed process and system. Various modifications to these implementations will be readily apparent to those skilled in the art, and the generic principles defined herein may be applied to other implementations without departing from the spirit or scope of the disclosed process and system. Thus, the present disclosed process and system is not intended to be limited to the implementations shown herein but is to be accorded the widest scope consistent with the principles and novel features disclosed herein.

What is claimed is:

1. A flow control valve comprising:
an intake socket;
an outlet socket spaced from the intake socket along a flow axis of the flow control valve;
a generally circular multi-orifice plate having a center and a plurality of orifices spaced circumferentially about the center and extending through the multi-orifice plate, wherein each of the plurality of orifices is located at a radial distance from the center of the multi-orifice plate such that each orifice can be positioned along the flow axis between the intake socket and the outlet socket by rotating the multi-orifice plate about the center; and
a gear wheel mechanism configured to rotate the multi-orifice plate about the center within a plane generally defined by the multi-orifice plate.

2. The flow control valve of claim 1, wherein a first orifice of the multi-orifice plate has a first cross sectional area and a second orifice of the multi-orifice plate has a second cross sectional area greater than the first cross sectional area.

3. The flow control valve of claim 1, wherein each of the plurality of orifices has a cross sectional area different from the cross sectional areas of the other orifices.

4. The flow control valve of claim 1, wherein at least two of the plurality of orifices have cross sectional areas between 25% and 75% of the cross sectional area of the intake socket.

5. The flow control valve of claim 1, wherein at least one orifice of the multi-orifice plate has a circular shape.

6. The flow control valve of claim 1, wherein at least one orifice of the multi-orifice plate has a non-circular shape.

7. The flow control valve of claim 1, further comprising a valve housing at least partially enclosing the multi-orifice plate.

8. The flow control valve of claim 7, further comprising a plurality of o-rings sealingly disposed about the flow axis between the multi-orifice plate and the valve housing.

9. The flow control valve of claim 7, wherein the multi-orifice plate further comprises a plurality of alphanumeric indicators each corresponding to a size of one of the plurality of orifices, the alphanumeric indicators being positioned on the multi-orifice plate such that, when a particular orifice of the plurality of orifices is positioned along the flow axis, the corresponding alphanumeric indicator is visible to an observer through an aperture of the valve housing.

10. The flow control valve of claim 1, further comprising a pressure sensor configured to produce an output indicative of a fluid pressure within an interior space of the flow control valve.

11. The flow control valve of claim 10, further comprising processing circuitry configured to calculate a rate of fluid flow through the flow control valve based at least in part on the output of the pressure sensor.

12. The flow control valve of claim 11, wherein the processing circuitry is configured to calculate the rate of fluid flow based on the output of the pressure sensor and a cross sectional area of an aperture disposed along the flow axis of the flow control valve.

13. The flow control valve of claim 1, further comprising a valve position sensor configured to produce an output indicative of a size of an aperture disposed along the flow axis based at least in part on an initial position of the multi-orifice plate and a number of rotations of a portion of the gear wheel mechanism.

14. The flow control valve of claim 1, further comprising a motor coupled to the gear wheel mechanism, wherein the motor is configured to actuate the gear wheel mechanism.

15. The flow control valve of claim 1, further comprising a handle coupled to the gear wheel mechanism, wherein the handle is configured to actuate the gear wheel mechanism when rotated by a user.

16. The flow control valve of claim 1, wherein a circumferential edge of the multi-orifice plate comprises a plurality of cogs configured to engage with a gear of the gear wheel mechanism such that actuation of the gear wheel mechanism results in rotation of the multi-orifice plate.
